(19) United States
(12) Patent Application Publication
(10) Pub. No.: US 2016/0070732 A1
(43) Pub. Date: Mar. 10, 2016

(54) SYSTEMS AND METHODS FOR ANALYZING AND DERIVING MEANING FROM LARGE SCALE DATA SETS

(71) Applicant: Gravity Ltd., Toronto (CA)

(72) Inventors: David Bastedo, Toronto (CA); Leigh HIMEL, Shelburne (CA)

(21) Appl. No.: 14/792,053

(22) Filed: Jul. 6, 2015

Related U.S. Application Data
(60) Provisional application No. 62/046,430, filed on Sep. 5, 2014.

(51) Int. Cl. G06F 17/30; G06Q 30/02

(52) U.S. Cl. CPC G06F 17/30324; G06Q 30/0201

(57) ABSTRACT

There is disclosed method of and system for performing the following steps: obtaining a data set comprising a plurality of datum; reviewing the data set to determine the presence of at least one of a set of monitoring traits which includes one or more monitoring traits; analyzing the data set to extract a secondary data set which includes data related to each of the datum having one or more of the monitoring traits; adjusting the contents of the set of monitoring traits based on consideration of the data from the secondary data set; generating a set of vectors, wherein each of the vectors comprises data indicative of the source of each datum; and, creating a key, wherein the key comprises a selected set of the vectors.

### CROSS-REFERENCE TO RELATED APPLICATIONS

This application claims priority to U.S. Provisional Application No. 62/046,430, filed on Sep. 5, 2014, which is incorporated herein by reference in its entirety.

### TECHNICAL FIELD

The present disclosure relates to systems and methods of reviewing and analyzing large scale data sets to extract and derive therefrom meaning in the form of market intelligence.

### BACKGROUND

### The Volume and Complexity of Social Media Data

The proliferation of social media has altered the landscapes for market and consumer research. The sheer volume and velocity of data results in more, and more quickly changing, consumer opinions and behavior; however, techniques for data collection, measurement and analysis have not kept pace. Volume is not the only complicating factor. The content of social media is also unique and almost constantly evolving. Despite these changes, market research approaches, and tools used to review and analyze data, have not changed substantially.

As a consequence of these changes and complicating factors, by the time marketing plans and programs (which may relate to a variety of subject matter including, without limitation, political and commercial marketing) are ready to go to market/intended recipients, they are already out of date. This results in substantial expenditures of money and other resources being misdirected. Thus, the major shift in the volume and makeup of available data has disrupted the business of many traditional marketing firms including, for example, advertising agencies, and market research firms. While the term “big data” is a buzzword for the industry, market research companies are lagging radically behind in dealing with such voluminous data in a timely and meaningful way.

The root of the problem is that social media outlets provide such a rich trove of publicly available information. This information covers innumerable topics and is subject to interpretation, to provide many meanings, each having varied and contextual significance. This vast and fast moving data set is and should be particularly interesting to market researchers; however, it remains largely inaccessible due to its immensity and complex nature. In particular, the market research companies continue to only use traditional quantitative and qualitative methodologies to bring insight despite the ever-changing nature and increasing scale of the modern consumer marketplace. These methodologies are quite time consuming, and are also rather costly, despite being ineffective.

In addition to being voluminous, social media data sets are complex, consisting of discrete data that are connected through relationships based on a large number of contextual and absolute factors including, but not limited, to user data, message content such as hashtags and links, as well as meta-data.

Data (e.g., social media messages) is typically made up of various constituent parts, including text of constantly evolving syntax and underlying contextual meaning. This includes, without limitation, abbreviations, complex punctuation and symbols denoting emotion or other expressions. Analysis yielding meaningful results is difficult for reasons including the brevity of individual pieces of data and the reliance on reference to external pieces of data (and the reliability and providence of such data) to establish meaning.

### Shortcomings of Existing Methods and Technology

Existing analytical technologies used on text and data retrieved via older and less dynamic media, including statistical descriptions, do not provide meaningful information when brought to bear on social media data sets. Some technologies have been aimed at determining the sentiment of individual pieces of data (i.e., whether a message is positive, neutral or negative towards a certain topic or theme). However, these technologies are not helpful in yielding useful interpretations of data obtained through social media sources because they fail to include analyses that glean as many meanings as may be derived from the complex language and immense volume of social media data.

Systems aimed at providing enhanced and/or real time real time analysis of data (e.g., social data, examined via text analysis, machine learning and pattern analysis) have) fallen short for a variety of reasons. A primary focus of many existing systems is on keyword prevalence rather than on the determination or identification of any themes, the prevalence thereof, or any contextual analyses. Typically, any derivation of meaning is done manually. Again, this is impractical with large data sets. Further, even if this known style of analysis is manually conducted, it results in missed context and/or significance as it fails to conduct the effectively multi-dimensional analyses. In most instances, existing systems and methods focus on solving a single problem—for example, seeking confirmation of an expected insight—rather than attempting analyses aimed at providing any deeper understanding or meaningful (and perhaps unexpected) insights on an ongoing basis.

That is, there is a tendency to focus merely on observations without any understanding of branding and marketing concerns, such that no true insight is provided, only relatively superficial analysis of bulk data without the benefit of any context.

Other systems may have brought to bear at least some understanding of marketing and advertising principles; however, there is no application of related technical principles. The result is often a focus on a very basic sentiment analysis as opposed to seeking to provide or unearth any new and more contemporaneous and timely understanding of how the data can be used or reviewed to derive additional meaning(s), many of which may be novel or unexpected. One glaring example of the weaknesses of existing types of sentiment analysis is that such methods yield misleading results when used on social data, given the unique and rapidly evolving syntax used in the underlying messages.

### Natural Language Processing and Deriving Meaning

An understanding of the relevant field of technology is facilitated by noting that the field of natural language processing (“NLP”) seeks to ascribe intended meanings to text based on characteristics taken from known and evolving sets of data. In the context of social media and similar online data forums, it must be appreciated that trends and evolutionary terms applicable more generally to language and communications media, will move at a faster rate. For example, the meaning of a term, or its significance, can change over time (or in different contexts). In the online world, the timeline can be quite short. A term used to describe an emerging phenomenon or trend will soon transition into mainstream usage and, eventually, will become passé. This highlights that, for analysis of data sets to be useful in a marketing environment, trends must identified earlier, or even predicted. Further, once a trend that is or is soon to be emerging is identified, it may be tracked and its significance determined with respect to decisions at a given point in time. The significance of terms (or traits) is, in many cases, cyclical and often follows a patterned life (along the continuum from prior identification, to increasing significance, to a crescendo, a period of diminishing significance, and, ultimately, becoming passé); but the time period taken by each stage will vary, underscoring the need for substantially real-time analyses to best position decision makers to take advantage of understood and observed insights vis-à-vis marketing, consumer or public influence, sales, or other goals. While numerous NLP toolkits may exist for analyzing traditional language and syntax for a given topic area, at least a dynamic and responsive element is lacking, particularly for the purposes of providing technologically enabled and assisted meaning extraction (e.g., an autonomous or substantially autonomous analysis engine that can extract meaning from massive and quickly changing social data sets). Analysis of social media data requires a multi-faceted approach, for example: processing non-standard punctuation and meta-data within an NLP framework; expanding keyword analysis to convey meaning and context (e.g., rather than simply a count of how many times a keyword appears in a data set); creating efficient and optimized systems and methodologies that can function on a substantially real-time basis with a large scale data sets; providing a user experience and interface that allows easy and selective access to these advantages features.

Existing market research and analysis techniques require and rely upon the use and effectiveness of significant manual efforts by human professionals. This type of analysis cannot be conducted in a practical or manner on a large data set. Further, a human user cannot detect all of the trends or patterns evident from such data or assess the relevance of such patterns, particularly when the trends or patterns may fall outside of the particular expertise of the analyst, or be quite different from what s/he may expect. Further, this deficiency of human analyses is even more apparent when considering the possibility of a user conducting selective and varied queries on a given, and up to date, set of data.

Looking to the volume and complexity of data available from social media and similar high volume, fast paced online sources, along with the aforementioned need to provide feedback and alter marketing and product/service plans as quickly as possible, and the deficiencies of existing systems, it is apparent that systems and methods are needed for assessing large scale pools of data including, in particular, data from social media sources.

### BRIEF SUMMARY

The present disclosure is directed to a method comprising using a computer to perform the following steps: obtaining, by a processing device, a data set comprising a plurality of datum; reviewing, by the processing device, the data set to determine the presence therein of at least one of a plurality of monitoring traits; analyzing, by the processing device, the data set to extract a secondary data set wherein the secondary data set comprises further data related to each of the datum having at least one monitoring trait; adjusting, by the processing device, the plurality of monitoring traits based on consideration of the further data; generating, by the processing device, one or more vectors, wherein each of the vectors comprises one or more path data elements, wherein the path data elements are indicative of the source of each datum; creating, by the processing device, a key, wherein the key comprises a selected set of the vectors; and, outputting, by the processing device, the vectors and the key for use in analysis of one or more further data sets.

In another aspect, each datum comprises one or more of: text elements and meta-data elements; and, wherein the reviewing comprises comparing the text elements and the meta-data elements to one or more of the plurality of monitoring traits.

In another aspect, the generating is based on the monitoring traits, and each of the vectors comprises a combination of one or more of the text elements, the meta-data and the paths, indicative of one or more characteristics of the source of each datum; and the characteristics comprise one or more of age range, geographic location, information reliability, income range, gender, and level of education of the source.

In another aspect, the text elements comprise one or more of letters, words, syntax patterns and punctuation.

In another aspect, the analyzing comprises: identifying any hyperlinks in each of the datum; identifying any user status details of a creator of each of the datum; identifying the source of each of the datum; determining any interrelationships between the monitoring traits, with relationship including details of any terms occurring in any of the datum having each of the monitored traits, with the details including relative timing of creation.

In another aspect, the secondary data comprises one or more of: content hyperlinked from the datum; identity of a source of the datum; geographic location of the source of the datum; and, timing of creation of the datum;

In another aspect, the adjusting further comprises: assigning a significance level to each of the monitoring traits and each of the further data in the secondary data set, based on one or more significance factors, setting an upper threshold and a lower threshold in respect of each significance level, removing from the monitoring traits any of the monitoring traits having the significance level less than the lower threshold; creating a set of emergent traits, wherein the set of emergent traits comprises any of the further data in the secondary data set having the significance level above the upper threshold; and, adding the emergent traits to the monitoring traits.

In another aspect, the significance factors comprise: textual proximity of a given one of the monitoring traits in the datum to other ones of the monitoring traits; the words, phrases, symbols and structures making up each datum in the data set; timing of the message in which the words or phrases appear; magnitude of a rate of change of prevalence with in the respective data set; time of creation of the datum; number of occurrences of the monitored trait within the data set; and, chronology of creation relative to a date of occurrence of a triggering event.

In another aspect, the method further comprises the step of revising one or more of the upper threshold and the lower threshold based on rates of change of the contents of the set of monitoring traits.

In another aspect, the method further comprises a step of further reviewing the data set to determine the presence therein of one or more of the set of emergent traits

In another aspect, the method further comprises performing consecutive iterations of the reviewing, the analyzing and the adjusting; measuring a rate of change between the contents of the data set after each of the iterations; and, ceasing the performing if the rate of change is less than a desired level.

In another aspect, the analyzing further comprises identifying destinations of content hyperlinked from the text elements and the meta-data elements, wherein the content includes additional text and the analyzing further comprises obtaining the additional text; and, the adjusting also includes consideration of the additional text.

In another aspect, the analyzing further comprises determining one or more paths between the monitored traits, wherein the paths comprise the path elements and wherein the path elements each comprise one or more words and phrases connecting a pair of the monitoring traits.

In another aspect, the analyzing further comprises recording a prevalence level for each of the paths for each of the monitoring traits.

In another aspect, the analyzing further comprises recording a plurality of pairs of tokens, wherein each of the pairs of tokens comprises one of the paths and a respective one of the monitoring traits.

In another aspect, the method further comprises determining a velocity of one of the monitoring traits, with the velocity comprising a rapidity of increases or decreases in occurrence of the one of the monitoring traits in the data set over a time interval.

In another aspect, the method further comprises deriving context from the prevalence level of each of the paths.

In another aspect, the deriving comprises drawing conclusions regarding one or more characteristics of each datum, wherein the characteristics comprise: age; income level; geographic location; employment status; verified social media account; date of account creation; number of posts by the user(s); nature of relationship with other users of a platform on which the datum was created or on other platforms; times listed and accounts that the user follows; gender; technology use level; level of sophistication; and, level of influence.

In another aspect, the method further comprises recording a time of creation of each of the vectors.

In another aspect, the method further comprises providing a user interface enabling population of the selected set of the vectors from the key for use in consideration of a set of user data to derive market intelligence therefrom.

In another aspect, the user interface comprises a plurality of guided selection elements for use in the population and the consideration wherein the guided selection elements comprise a plurality of menu lists from which selections may be made in respect of a plurality of determination variables.

In another aspect, there is disclosed a non-transitory computer readable medium storing a program causing a computer to a process comprising the following steps: obtaining a data set comprising a plurality of datum; reviewing the data set to determine the presence of at least one of a set of monitoring traits which includes one or more monitoring traits; analyzing the data set to extract a secondary data set which includes data related to each of the datum having one or more of the monitoring traits; adjusting the contents of the set of monitoring traits based on consideration of the data from the secondary data set; generating a set of vectors, wherein each of the vectors comprises data indicative of the source of each datum; and, creating a key, wherein the key comprises a selected set of the vectors.

In another aspect, there is disclosed system for market analysis and intelligence derivation, the system comprising: a processing device for obtaining a data set comprising a plurality of datum; a review device for reviewing the data set to determine the presence therein of at least one of a plurality of monitoring traits; an analysis device, for analyzing the data set to extract a secondary data set wherein the secondary data set comprises further data related to each of the datum having at least one monitoring trait; an adjustment device for adjusting the plurality of monitoring traits based on consideration of the further data; a generation device for generating one or more vectors, wherein each of the vectors comprises one or more path data elements, wherein the path data elements are indicative of the source of each datum; a creation device for creating a key, wherein the key comprises a selected set of the vectors; and, an output device for outputting the vectors and the key for use in analysis of one or more further data sets.

There is also herein disclosed use of the methods disclosed herein to derive market intelligence from the data set.

In related aspects, a computing apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as computer servers, personal computers, smart phones, notepad or palm computers, laptop computers, and other computing devices of various types used for providing or accessing information over a computer network. Similarly, an article of manufacture may be provided, including a non-transitory computer-readable medium holding encoded instructions, which when executed by a processor, may cause a client-side or server-side computing apparatus to perform the methods and aspects of the methods as summarized above.

### BRIEF DESCRIPTION OF THE DRAWINGS

Embodiments are illustrated by way of example in the accompanying figures, in which like reference numbers indicate similar parts or method steps, and in which:

FIG. 1 is a block diagram depicting computer hardware that may be used to contain or implement the program instructions of a system embodiment disclosed herein;

FIG. 2 is a flow chart depicting the steps in a method illustrative of those disclosed herein;

FIG. 3 is a flow chart depicting sub-steps illustrative of those comprising step 206, shown in FIG. 2.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not limit the scope of the disclosure.

To facilitate the understanding of this disclosure, a number of terms are defined below. Terms defined herein have meanings as commonly understood by a person of ordinary skill in the areas relevant to the present disclosure. Terms such as “a”, “an”, and “the” are not intended to necessarily refer to only a singular entity, but include the general class of which a specific example may be used for illustration. The terminology herein is used to describe specific embodiments of the disclosure, but their usage does not limit the disclosure, except as outlined in the claims.

Various embodiments of systems and methods according to the present disclosure are described. It is to be understood, however, that the following explanation is merely exemplary. Accordingly, several modifications, changes and substitutions are contemplated. For the purposes of the present disclosure, it will be understood that social media systems is but one example of a high volume, fast paced system of content dissemination and subsequent commentary. Similarly, other systems of dissemination of information and commentary may likewise be susceptible of more efficient and more meaningful analyses by way of systems and methods herein disclosed.

By way of general outline, the systems and methods disclosed herein may be used to process a given set of data and effectively unpack its contents and underlying and connected data. This includes using, for example, NLP analysis geared towards the particular challenges of ordering and deriving meaning from unordered, large volumes of social data. In some embodiments herein disclosed, the unpacking and ordering may be effectively multi-layered and/or multi-dimensional, in that constructed there are multiple data paths to and connections between terms. This construction of paths aids in illuminating interrelationships not apparent from conventional keyword analyses, and the significance of which is greater based on analysis of an extremely large scale date set. In some embodiments, users may be enabled to make custom queries or selectively access the contents and results of queries of the data set (e.g., by selecting certain ones or bundles of vectors, or paths to terms, as herein described).

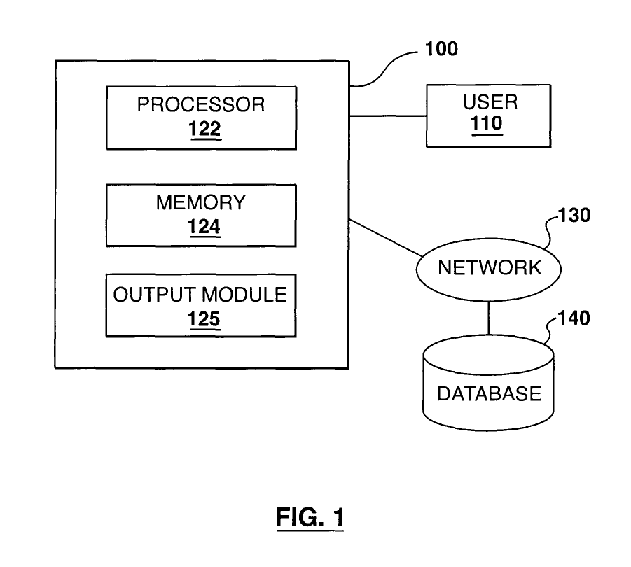

Looking more particularly to FIG. 1, systems 100 as disclosed herein may include a database 140, which may be distinct from a memory 124. The memory 124 and the database 140 may be the same, and/or the database 140 may be external to and in data communication with the system 100. The system 100 may be in data communication with other entities, such as external data sources and/or a remote user (not shown), via a network 130, which can be any type of electronic data communications network, whether implemented in a wired and/or a wireless manner. Output may emanate from an output module 126 in the manners described below. The system 100 may include or consist of a personal computer, a server, a cloud computing environment, an application or a module running on any of, or combination(s) of, these platforms.

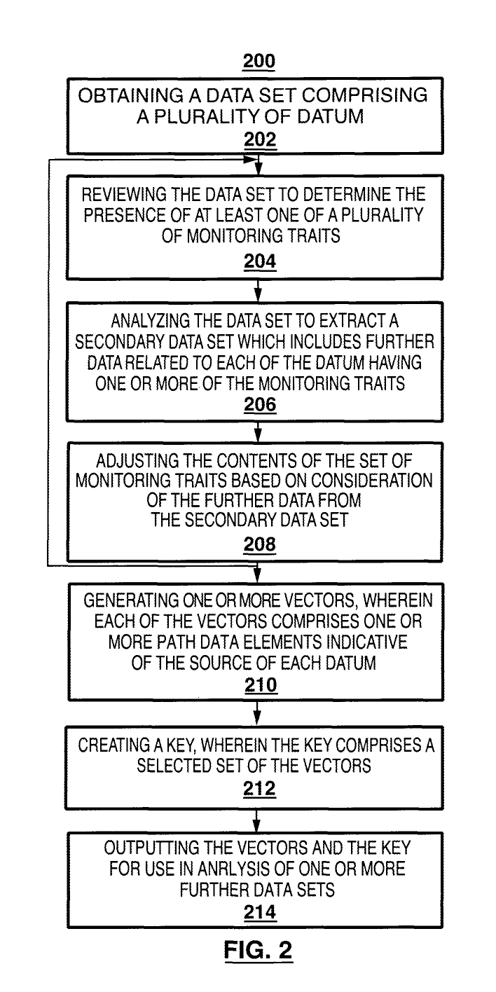

FIG. 2 is a flow chart illustrating an operation 200 of the system 100, which is configured to implement the operation 200. The operation 200 can be performed by the system 100, or any system structurally/functionally similar to the system 100. Particularly, instructions associated with performing the operation 200 can be stored in a memory of the system 100 (e.g., the memory 124 of the system 100 in FIG. 1) and executed in a processor of the system (e.g., the processor 122 of the system 100 in FIG. 1). As shown in FIG. 2, the operation 200 includes, at 202 (for which purpose the processor 122 can be configured), obtaining a data set comprising a plurality of datum. In some embodiments, the data set may be accessed via the database 140, which may be external to or a component of the system 100. The data set may alternately or also be retained in the memory 124 of the system 100. The operation 200 of the system 100 may, as described herein, result in holding, receiving, adding to, or purging data in the data set. Each datum includes one or more of: data elements which may comprise text elements, and associated meta-data. More specifically, the text included in the datum (e.g., the text of a sound needle message). Elements may comprise one or more of letters, words, syntax patterns and punctuation. In some embodiments, the database 140 and/or the memory 124 can be populated with data provided by a user; however, the data may also or alternatively be obtained or supplied via additional and external sources. There may be some overlap between text and meta data elements, in that content provided in a message may link to other content; however, types of meta-data may include, for example, Open Graph Protocol, and information including, for example: title, description, image, keywords, and author (e.g. the source account of the message). In some aspects, an Application Programming Interface (API) may be provided which enables disclosed systems to connect to multiple third-party systems, each having its own set of unique data that is available to access. Examples of social services that may be queried include: Facebook™, Instagram™, Bit.ly™, YouTube™, Twitter™. In an example of a Twitter™ message (or, “tweet”), text elements may include the body of the message and meta data elements may include details of the source account as well as information that may be linked or unpacked from the message, as well as user account details.

Examples of potentially available meta-data provided by such services includes share count, “like” count, comment count, click count and comments box count. Analyses may be performed upon, for example, the following which may have been reviewed as data elements, meta data elements, or linked or otherwise unpacked therefrom: patterns of letter, case and punctuation combinations within text strings used when analyzing text; parts of Speech (POS) word combinations; patterns of text usage in combination with POS & technical or social metaphor—link, hashtag, @, image, video; patterns based on identified emergent trends; text position, volume of use, type of link, domain; reduction map information for categorical inference, such as location, occupation, age, gender, political beliefs and interests; and, relationships and inference between a target message and the context and syntax between the multiple dimensions of datum it sits within. Relationships might infer the relevance or contextual importance of a word, phrase, pattern, user, or content type.

Looking more specifically to the operation 200 showed in FIG. 2, it, at 204 (for which purpose the processor 122 can be configured) reviewing the data set to determine the presence of at least one of a plurality of monitoring traits (which includes one or more monitoring traits). The monitoring traits include, for example, key words, timing of a datum, and specific contents of each datum (for example, proximity of certain words or terms to other words or terms, and the like. The step of reviewing includes comparing the text elements and the meta-data elements to at least one of the monitoring traits. The monitoring traits may be pre-selected (for example, by way of earlier iterations of the methods herein disclosed, or by user selections) and stored in the memory 124 and determined through the potentially iterative processes herein described. The nature of the comparison is one of matching text and meta-data elements to identical or substantially identical ones of the monitoring traits.

At 206, (for which purpose the processor 122 can be configured) the data set is analyzed to extract a secondary data set which includes data related to each of the datum that displays one or more of the monitoring traits. By virtue of exhibiting or including one of the monitoring traits, further consideration is needed to examine, for example, content linked from each datum displaying one or more of the monitoring traits. As an initial trait of interest has been identified as present in the datum, the secondary set is extracted to see if there are additional layers of connections between each datum and the others (including, notably, any associations that may not otherwise have been apparent) The set of monitoring traits may then be adjusted to include any of these additional traits that are unearthed as being sufficiently common or connected among datum that display the monitoring trait(s). In this regard, the potentially iterative nature of the operation 200 (see arrow 216 in FIG. 2) is clearer. The analyzing may include, for example, at least the application of NLP techniques as herein described, and identifying any hyperlinks or other linked content in each of the datum displaying one or more of the monitoring traits. An identification of any user status and details of the creator of the datum may also be performed, along with identifying the source of each of the datum. As a further example, relationships between each of the monitoring traits and the other monitoring traits may also be identified. Such relationships may be defined by way of any terms commonly occurring in any ones of a particular datum displaying multiple ones of the monitored traits. These relative timing of creation of the respective datum may also be significant as certain cascading message may be indicative of an emergent event or phenomenon. This is apart from explicit indicators of correlation such as hashtags but may be separately indicative of the same event/trend.

The analyzing also includes identifying destinations of hyperlinked or otherwise linked content provided in the text elements and the meta-data elements, along with obtaining the text of the destinations and using it to populate a further data set. This further data set may be made the subject of consideration when adding or deleting monitoring traits. That is, the further data set may suggest that the significance of a monitoring trait is diminishing or increasing (or that a new one should be added).

The analyzing may also include determining one or more paths between the monitored traits. These paths will include groups of one or more text or other items connecting a pair of the monitoring traits. The disclosed systems and methods may include what may be referred to as a path-to-target method which groups all of the paths (i.e., routes through connections of various terms based on search criteria that link such terms via context and content) to a target word or term and sorts by prevalence and ascribes significance. Paths will have different lengths and constituent elements, with each of these properties supporting certain conclusions vis-à-vis commonalities and characteristics of the sources of the data making up the paths.

While the operation 200 has been described above, provided below is a detailed example to provide further context and understanding.

The analyzing may also include recording a plurality of pairs of tokens, each made up of one of the paths and its destination monitoring trait. In some embodiments, the NLP analyses may yield as an output a series of paired tokens. The first portion may contain the path, indicated as a variable, and the second half of the pair, is the trait (which may be, for example, one or multiple words). The variable may be, for example, a reference to the word adjacent to the term in the particular result from the data set. Queries may then be run on multiple results from the data set, for example, based on either one of the tokens. These queries may include searches or sorts, which, depending on the queried term, may yield all the “paths” to a given term, or may provide information that illustrates the context or contexts in which the term is used. A prevalence level is also recorded for each of the various paths leading to each of the monitoring traits.

At 208, ones of the monitoring traits may be deleted, or new ones may be added, based on consideration of the secondary data set (for which purpose the processor 122 can be configured). In some embodiments, a significance level may be assigned to each one of the monitoring traits and to each of the data in the secondary data set. These significance levels are set based on one or more significance factors, and may be set by the user and stored in the memory 124. An upper threshold and a lower threshold will be set in respect of each significance level. Any monitoring traits having a significance level less than the lower threshold will be deleted and will not be used in subsequent iterations of the operation 200, if any. A set of emergent traits will be created, made up of any of the data from the secondary data set having the significance level above the upper threshold. The emergent traits will be added as monitoring traits for consideration in subsequent iterations, along with those of the monitoring traits remaining.

Examples of significance factors contributing to each significance level may include: textual proximity of a given one of the monitoring traits in the datum to other ones of the monitoring traits; the words, phrases, symbols and structures making up each datum in the data set; timing (absolute and relative) of the message in which the words or phrases appear; magnitude of a rate of change of prevalence with in the respective data set; time of creation of the datum; number of occurrences of the monitored trait within the data set; and, chronology of creation relative to a date of occurrence of a triggering event. Triggering events may include any set of criteria that may be identified and measured. This includes, for example, events—e.g., an election, an advertising campaign, a concert, a sporting event, a car accident—all of which may present themselves in digital form. For example, this presentation may include names of participants/affected parties (either passive or active participants), key words, titles of documents, words contained in blog links and news stories, descriptions in meta data, hashtags and keywords around photos. Further examples of significance factors include increased use of a word, term, or series of words/phrases at any time, over an identified threshold, as relates proximally to an event, or an onslaught of photos and digital social content contextually linked to a particular time and/or place and/or type of user.

The revised set of monitoring traits, which includes the emergent traits, may then be re-compared to the data set, and the analysis and adjustment undertaken again, on an iterative basis, as herein discussed.

The operation 200 also includes, at 210, generating a set of vectors (for which purpose the processor 122 can be configured). The vector module 132 may be configured to generate such vectors. Vectors may be selectively generated or implemented by users based on preferences or desired data set examination parameters. In other embodiments, the database 140 and/or the memory 124 is configured to generate the vectors in a manner similar to as described herein. The vectors each include data indicative of the source of each datum, which may be used to ascribe significance to these users or make determinations as to other traits that such users are likely to display. These determinations aid in understanding what a certain demographic may be commenting on online, as well as the nature of the commentary. This data is useful in assessing marketing or other considerations. The vectors are generated based on the set of monitoring traits (which may include the emergent traits, if any), with the vectors being combinations of one or more of the text elements, the meta-data and the paths. Each vector is, by itself and in combination with other vectors, indicative of one or more characteristics of the source of each datum. These characteristics are many and may change by way of analyses of a given set of data; however, examples include the entity type (e.g., lone human, corporate account, automated account), age range, geographic location, informational reliability, income range, gender, and level of education of the source. The disclosed “vectors” are generally core to the interests of specific marketing clients or users. Further, these vectors could include combinations of language, syntax and other factors that are indicative of a certain age range of a user, or numerous other characteristics. For example, certain data may suggest that the social media user behind a particular comment or linked content is a teenager as opposed to a person over thirty years of age. Generally speaking, the types of determinations and conclusions that may be drawn, or inferences that may be made, will be dictated by the size and content of the data set. Additional dictating criteria may include the specific types of algorithms and patterns that are used to query the data set.

The operation 200 also includes, at 212, creating a key in respect of the data set (for which purpose the processor 122 can be configured). The key includes a selected set of the vectors. The key may include vectors which, alone or in certain combinations, may be applied to the data set or another set, to yield market or other intelligence, as the prevalence of the vector traits supports various conclusions being drawn.

The operation 200 may also include determining a velocity of one of the monitoring traits. Velocity of terms (i.e., the rapidity of increases or decreases in prevalence of use and the degree to which there is contextual relevance) and emerging trends, e.g., a new “hashtag”, may suddenly and rapidly emerge as highly significant based on velocity and usage (e.g., time, frequency, source, and context) of the word. This velocity represents the rapidity of increases or decreases in prevalence of use of the one of the monitoring traits over a given time interval.

The time interval may be selected as, for example, the week following introduction of a new advertising tagline or the like, to monitor usage of that term. Analyses by way of the operation disclosed herein would not be limited to volume of comments/uses, but would also include further intelligence, as detailed herein.

As noted above, the operation 200 may include performing consecutive iterations of the reviewing 204, analysis 206 and adjusting 208. After each iteration, a rate of change between the contents of the set of monitoring variables would be measured. The iterations would cease if the rate of change is less than a specified level. When reviewing and/or analyzing live or substantially live data, the iterative process may be created on an ongoing basis. While not every change is shown at the high level, they are accounted for at each iterative update. An iterative update would be used to update key data at regular intervals.

Conducting analysis of social media data on a substantially real-time basis may, in some circumstances, be highly preferable; however, other situations may arise. Examples include where data from a window of time before, after or surrounding a particular triggering event, or series of events. These events may include the previous iteration of a sporting or other social, political, or otherwise interesting (e.g., to the party instructing or conducting the query). Data from that time period may be most significant in assessing steps to be taken prior to the next iteration. Other significant events may determine the selection of the window of time to monitor when seeking to provide means of contextualizing a data set for a particular industry or business. Further, in some industries, it may take less time for data to become stale or to be of diminished significance. Identifying trends and timing can have a substantial impact on a given business. For example, of interest to many businesses at present is consumer and market insights with respect to “cord cutting” or the trend towards a move away from hardwired, package based services, in favour of more modern modes of content and information delivery.

In different industries, consumer approaches and other contextual market factors will determine the speed at which and if such changes are made. In many cases, a failure to appreciate the state and likely coming state of the marketplace could have serious consequences. Similarly, an ability to more readily appreciate these states than one's competition could be highly advantageous. As such, the capacity of the user to select certain vectors to analyze a specific set of data (unpacked and ordered from an overall data set (for example, as discussed above)), and to do so in a customizable manner, is highly advantageous. That is, a user may effectively turn on or off one or more of the vectors to effectively create a customized lens through which to view the data set of interest.

Through the iterative reviewing 204, analyzing 206 and adjusting 208 operations, the derivation of meaning not necessarily apparent from an initial review may be facilitated, by way of an enhanced understanding context of the various words, phrases, symbols and structures around them, among the monitoring traits. This provides users with the ability to identify and catalogue the prevalence of not just words but to discern and catalogue themes and topics in large data sets not possible using traditional human analysis of data samples, nor with existing keyword analysis technologies. The volume of data reviewed and the speed and depth of the iterative review reveals trends not apparent from a single, manual review, and the extraction of further data in respect of each datum allows for a greater understanding of significance of individual words, phrases.

### An Illustrative Example

An example of a sample use of the operation 200 is detailed below, so as to further illustrate aspects thereof. This is understood to be but one illustrative example and not a statement of a limitation of the operation 200.

In this example, the user (see 110 in FIG. 1) wishes to be able to identify messages that are sent by “millennial” social media users (e.g., persons having birth years roughly between the early 1980s and early 2000s) who are Mothers living in or around Toronto, Ontario, Canada, for the purposes of refining and better targeting, for example, advertising and marketing messaging to such persons.

The user first selects a plurality of monitoring traits. These traits may be selected from a graphical user interface accessible via the processor 122, including by way of drop down menus of traits provided under various categories. In this example, the user 110 would select the following traits (wherein under each group various traits are listed in a comma delimited fashion or a JSON document):

### Example Traits:

Canada Specific Inclusion (positive traits): location_canada>0, Canadian Urban Specific: location_canada_cities>0, Canada Provinicial: location_canada_on>0
Is a person Exlusion (negative traits): (these items will be removed) filter_blacklist_gambling=0, filter_contest<0.3, filter_non_person<0.35, hints_business<0.3
Twitter Stats Exclusion (negative traits): default_profile=True & default_profile_image=True, favourites_count<1, Friends_follower_ratio<20, protected=TRUE, account_age<120 (days), status_count<100, RT rate>20
Positive traits for (Female) social users who are (millenials): Is a Female: filter_female>0 & filter_mothers>0—considered together in this instance, hints_health_general, hints_health_general, hints_job_title_designation, hints_job_title_designation, hints_life_events, hints_language_youth, hints_technology, segment_millenial_moms, socialStems
   These monitoring traits will be stored in the memory 124. A data set will be obtained (see step 202 in FIG. 1), via the network 130 and from the database 140. In this example, the data set includes a multitude of social media messages posted by users of the Twitter® platform. These messages would be provided and stored in text format.

The data set will be reviewed (see step 204 in FIG. 2) with regard to the monitoring traits. The processor 122 compares the textual, quantitative aspects, or qualitative aspects of each monitoring traits to each of the social media messages in the data set.

For any of the social media messages showing one or more of the monitoring traits, further analysis will be conducted (see step 208 in FIG. 2) to extract the secondary data set. In this example, that secondary data will include any content hyperlinked from these ones of the social media messages, contents of any “retweets”, contents of any mentions, user profile details of person sending the analyzed message.

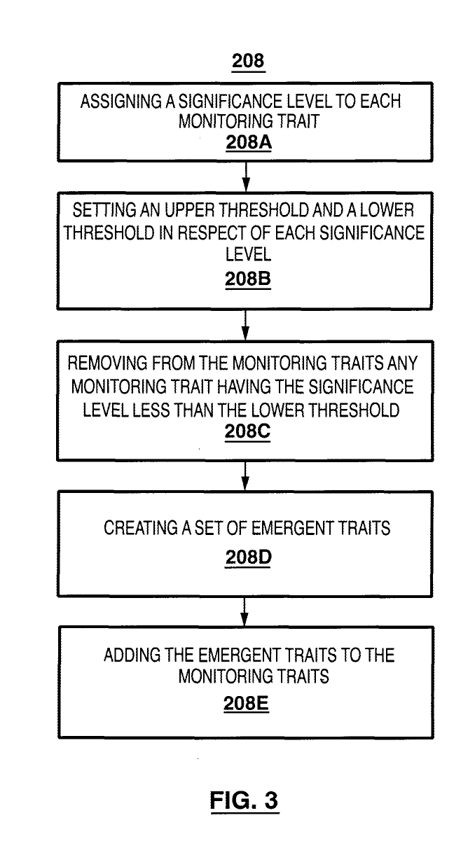

As detailed in FIG. 3, a significance level will be assigned to each monitoring trait. In this example, the significance level will be a percentage of the social media messages showing the given trait (sub-step 208A). More specifically, in this example, a significance level of 10% will be set in respect of the term “Ontario”. Upper and lower thresholds may be set (see 208B) in respect of each significance level (which may alternatively be an absolute cut-off) and stored in the memory 124; in the case of “Ontario”, being 12% and 8%, respectively. Any of the monitoring traits having significance levels beneath the lower threshold will no longer serve as monitoring traits; here, with “Ontario” falling above the lower threshold, it will remain as a monitoring trait.

The secondary data set will also be reviewed to create a set of emergent traits (see 208D in FIG. 3). Each emergent trait will be a word, terms or other characteristic (similar in format to those among the monitoring traits) found in the secondary data set with sufficient commonality (i.e., above a cut-off point for inclusion). For example, if the term is found in 15% of the additional messages

At this stage, additional iterations of steps 204, 206 and 208 may be performed (as described herein) to further refine the monitoring traits, or to review additional data, which may be provided or updated.

Once any iterative operation of these steps has ceased, vectors will be generated (see 210 in FIG. 2), each including text and path data elements. The text elements will be terms (for example monitoring traits) relating to the datum, and path data elements will be data connecting to the source of the datum.

For example, if the most commonly occurring monitoring trait is “#YOLO”, vectors may include terms connected to occurrences of that monitoring trait, such that characteristics of users tied to that term (sometimes using it themselves; sometimes sharing common traits with users using it), to support conclusions about the user creating a given datum. More specifically, with a example user who is connected to postings commonly featuring the hashtag “YOLO”, and otherwise to messages commonly featuring the text “Toronto” or the airport code “YYZ” posted by users in that geographic region, a conclusion may be drawn with some confidence that the example user s a millennial in the Toronto region.

A key may be created via the processor 122 and stored in the memory 124 which comprises a selected group of the vectors. A vector comprising users with high incidence of retweets of messages including the hashtag YOLO and themselves using the text YYZ may be one vector. Another vector may be users posting the text Toronto and publicly listing a birth date in 1992. A selected set of vectors may be aimed at users posting with a known and sufficiently high frequency, in an example where the vectors are to be used to search for high volume Twitter® platform users to target with products, such that certain vectors would not form part of a key generated for that purpose. In another instance, for example, the user 110 may wish not to consider location, instead preferring, for example, to more readily identify millennial users without preference as to geographical location. This may be in support of targeting millennials for a campaign encouraging behaviour not necessarily linked to a particular location (e.g., online commerce) or cross geographic boundaries (e.g., music festivals).

An output of the operation 200 may consist of the vectors and key(s) for use in analysis of a further data set. Outputting (to a screen for printing, or visualizing through graphs and charts, or export, or to a database or the memory; or for use via both) may be conducted in a manner such that generated vectors and/or keys are available to multiple users in a controlled access manner (e.g., via user accounts). Further, this output may be in a format

It will be appreciated that the monitoring traits selected above at the outset of this example may have been developed by way of an earlier operation of the system with a different data set (e.g., via setting of significance levels in the manner noted above, which populates a first group of monitoring traits, based on which iterations of the operation may refine and build)

Turning from the detailed example and back to aspects herein disclosed, in some embodiments, additional variable such as patterns of syntax and parts of speech of single or combined constituent elements of the terms may be unpacked via data set analyses, so as to yield additional context and insights.

An exemplary focus of the iterative review of the data set is to identify words and terms, as well as the most prevalent path-to-target, and other contextual factors, as described above, for each of such words and terms, ideas or concepts. In some instances, the initial set of monitoring traits may comprise a predetermined set of words and/or terms. The predeterminations may include establishing a “cluster” of words, phrases, & terms via supervised or unsupervised methodologies, or a combination of both. Once established, the “cluster” may be repurposed. One such repurposing would be to constrain a data set for rendering more rapid analysis. Any initially analyzed data set may serve as a basis for populating and training sets of variables to enable extraction of insights and context for the terms therein, and for identification of additional, significant terms.

The provision via a user interface of the ability to turn certain aspects of the analytical framework on and/or off provides users with means of optimizing variables such as speed and/or the degree to which a query or operation is detailed and targeted, and the particulars of the target.

The disclosed analyses incorporate machine learning, semiotics, cultural and language analysis and pattern recognition, to take observed data and turn them into insights, by way of utilizing vectors and keys developed from earlier data sets to more readily gain insight when faced with additional data sets. The system thereby provides a tool to assist with and be an input to, for example, overall auctioning and strategy development for marketing insights. Significance of terms may be derived via a weighted analysis thereof including analyses of constituent and related elements (e.g., Twitter® hashtags present in datum along with all links shared, metadata from links, content in and linked from such links (images, video, title, description, keywords, etc.)). In some instances, terms may be weighted by way of position of use, and terms, context and content are weighted by user and content identified with them to provide context for future decisions. One set of tools, for example, searches out the use of a token or keyword in the datum at the root level of a word and clusters all such uses together to enable the identification of patterns. Once identified, the words, tokens and patterns can be added to a vector and used to further identify thoughts, ideas, patterns meaning and context.

In some instances, metadata associated with the source of a term, e.g., age, income level, geographic location, employment status, etc., may be circumstantial indicators of the reliability and significance of the data s/he or it provides, supporting the accuracy of any inferences to be drawn therefrom.

For example, any reference about being a mother, daughter, or grandmother would lead to an inference that the source is a female. The more data that, after analysis, support a given inference, the stronger the correlation that may be made between the data and the inferred result.

As another example, age may be inferred based upon language used in terms of certain words, turns of phrase, cultural references; all of which may be combined with context to the time of the occurrence and possibly to the location of the occurrence—e.g., at a concert for an artist whose performances are known to be predominantly attended by a certain age demographic, to support and inference that the data source is within a certain age group

As yet another example, data source that is known as a verified account provides an indication of authenticity speaks to the position of the source as being some type of influencer or a reliable source of information (e.g., about him or herself or the organization on behalf of which the information has been provided). This type of user data may be drilled down from based on additional public information, to assess the reliability of the content, as well as to influence how it is to be interpreted. Data points that may be of interest in this regard may include, for example, date of account creation (e.g., Twitter, Facebook, etc.), number of posts by the users, volume of followers, times listed and accounts that the user follows. Each of these factors may likewise be assessed in respect of the accounts linked to the account of interest, to provide for a more layered, contextual analysis. Overall, this information allows for drawing of more supported conclusions related to the activity of and content emanating via the account under scrutiny.

As an example, text relating to a certain sport could lead to information regarding what team is the favourite team of given user. This content may include, for example content that is known via analyses to be the name of a player, a sports team specific hashtag(s), references to a city name or region, as well as references to local television station names and channel references.

The content of a user's public profile, on a social media or other online platform, as well as that of his/her/its messages (as well as similar characteristics determined in respect of users associated with the given user) can lead to conclusion regarding numerous factors of interest, including for example, the following: age; gender; technology use level, level of sophistication; influencer status (e.g., in a specific field such as technology, entertainment, advertising, health and wellness, etc.; or a certain demographic, e.g., teens, mothers, millennials, etc.); profession/industry; geographic location; brand affinities (e.g., through association with corporate users, and the use of terminology related to certain brands, e.g., taglines and trademarks); social media sophistication (based on behaviour and language choices); and primary social use factor (which may or may not be applicable; e.g., a user geared towards contesting/couponing, connecting with friends, reviewing and commenting on news/politics, seeking entertainment through memes/jokes, or supporting a cause or organization, etc.).

It will be appreciated from the present disclosure that the various factors laid out above could, each on their own or in combination with other factors, be used to derive insights from the content provided by a certain source of information. This is not limited to the information source itself, but may extend to other users having similar characteristics and interests, or having been shown to be influences by sources such as the one analyzed. Certainly, given the volume of sources of social media or other online text data, it will be appreciated that the volume of analyses and inter-relationships reviewed and scrutinized by way of systems and methods of the present disclosure is beyond that which may reasonably conducted in any manual or conventional manner.

Discrete pieces of text or other information extracted from social data may, in some cases, belong to multiple vectors. By coding and associating pieces of data with the vectors to which they belong, social data sets may be ordered and more complicated and layered, yet still significant, relationships between terms, may be observed. This deeper dive into the data set facilitates the extraction of meaning and allows more reasonable and reliable conclusions to be drawn based on observed patterns and trends. Using the types of machine implementation herein described allows for processing of the types described herein to be accomplished (as it is not something that a human could manually accomplish) and for it to be completed in a timely manner. In the context of market research, this facilitates the making of more informed decisions regarding where to allocate spending and other resources. This relates not only to the content, media and timing of advertising materials, but also to the properties of product and service offerings.

The disclosed systems and methods may include means for determining and the determination of a standardized set of templates of approaches to develop archetypes by analyzing social data in a specific way with an algorithm to populate the template. These archetypes can be used to present the observations and insights, segmenting them in a number of different ways and, in some embodiments, in accordance with the specifications of a given system user.

The disclosed systems and methods include methods of analyzing text data, preferably including real time and historical social data, to derive meaning and patterns that can be mapped on a strategic framework. In some embodiments, the framework may be particular to the aims of a given advertising campaign or the needs of a particular client in a particular industry; however, many frameworks may be easily used to obtain insights relevant to the needs of substantially any business.

Notwithstanding the foregoing, the overall scope of analysis may not be so limited. The data set yields not only message content but publicly available details of users, as well as linked content (which may itself be available for further analysis). In these regards, the overall data set (which may grow or otherwise have its contents altered) may be more closely examined to extract further and more contextualized meaning. An aspect of these types of analyses may include providing means of identifying the most frequently used groups of words in a data set, as well as locating and counting Shingles (i.e., groups of a number of words, the number being defined by the variable X) or NGrams (i.e., groups of a number of letters, the number being defined by the variable N) in social media data. In some instances, the words that precede and/or follow a given Token (i.e., an individual word, letter, symbol or piece of datum) may be determined. These words/datum may then be categorized as target words or terms for further analysis to determine their prevalence in the data set, potentially yielding further meaning from the data set. In addition, relationships between different Shingles, NGrams and tokens may be observed and further meaning derived from these relationships.

Some examples of common relationships between a two word Shingle, may be determined by analysing the percentage of the population wherein one word is used with another when both are used in a piece of data. (e.g., Happy Birthday)

For example, if Word 1 (“Happy”) and Word 2 (“Birthday”) are each used 100 times, the percentage of times that the words are used together and the order in which they are used may serve to identify those two words together being a matching pair.

Once identified as being matching, a more detailed analysis of the relationship status of the two words together, vs. the status of other words pairs containing the individual tokens, may be undertaken.

For example, two words may in certain circumstances present a significant correlation between them, with the inference being that the pair is most likely a name.(e.g., “Mick+Jagger”) Additional factors related to other words used within a given proximity to the terms of interest may yield additional support for the inference that is drawn (e.g., “rolling, stones, concert, music”).

Relationships may be defined by the use of words or terms together within the context of a data set. These could be feelings, thoughts, slang terms, etc. Being able to identify the relationships also enables identification of when the relationship between established words changes, with such changes being tracked and measured, to inform later inferences and attributions of significance to certain terms. This is an element of determining the current status of a term and learning from that the significance of other terms.

Also disclosed herein as part of the analyzing is use of a link extractor tool that unpacks and analyzes meta-data of content that is linked or referenced within social data. This provides a further layer to the system through which system users may derive meaning from social data (which, when seeking meaningful relationships in many multiple data sets, is considerably more difficult).

The initial data set may be obtained from various sources, including a particular user desirous of analyzing a given set of data, various commercial providers of bulk data, and other sources to create a key based on vector and other categorization criteria. Keys may be created on different bases (i.e., different groups or clusters of vectors and other criteria) and/or updated either by user selection or when the data set grows or is otherwise altered. In some systems or methods, the process of creating and refining vectors and underlying keys may be iterative. Vectors themselves may in some embodiments comprise categorized layers of connections to words or terms. A word or phrase may be categorized multiple times on different bases. As a data set is iteratively processed, the results may dictate alteration and/or addition of vectors.

Thresholds will, as noted, be set so that the significance of terms may be monitored and assessed. Changes in significance (as monitored through prevalence, location, velocity and timing, etc.) of a term may dictate that such a term should be re-categorized or removed from certain vector categorizations or from the monitoring terms.

Each piece of content that is processed will result in an indexing of the operations performed on it, along with its individual components. Further, the results of any analysis of the linked content may be tied back to the result in which the link appeared, as well as the user that posted/shared it. Content may be analysed separately—indexed etc. —as well within the data set it was collected within.

The data sets that have been processed will form a baseline data set that may be analyzed in a manner desired by a user. The manner of analysis may include, for example, review of particular indexed or processed content, review of the parts of speech provided in any messages making up the data, review of extracted content (e.g., links, etc., and any underlying data), selection of various one of vectors or clustered sets of vectors, and others. These customizable means of reviewing facets of the data set allow users to easily retrieve.

Initial processing of artifacts is conducted in order to build a baseline iteration of the data set. Text inputs are processed in the manner described above so as to extract therefrom data and create and refine the vectors based on new or changing observed relationships between terms of interest and the discovery of additional terms of interest (e.g., hashtags often appearing in the same messages or a hashtag commonly appearing when a message including a certain hashtag or keyword is retweeted, messages commonly being retweeted by accounts known to be authoritative, highly followed or otherwise significant, etc.). Patterns and associations may be discovered, reinforced or undermined as the data set grows. As discussed generally above, the significance of data may be diminished once it is sufficiently aged (either in absolute terms or relative to the underlying event giving it significance). The initial processing may in some cases be iterative as more sources of data or vectors is added, as generally represented in the exemplary process diagram shown in FIG. 2. After any iteration of the process a date and time specific key will be generated as a data set is processed—it is processed against a series of “customized” clusters. Each cluster is composed of several levels categorized and prioritized information. Each piece of information is data and time stamped. The key contains the categories and IDs of each piece of information. This is saved so that it may be recreated exactly for future or baseline comparisons of data.

Various elements of text processing that may be undertaken as parts of systems or methods according to the present disclosure are detailed below: text artifacts may be processed to remove any artifacts including messages including indicia of insignificance related to the content of the message, the related user or other criteria. A set of rules for exclusionary purposes may be created at a global level and content level.

Items that may be excluded include, for example: “bot” accounts on the Twitter® service or other social media services/outlets, as well as accounts with default images and no tweets, and accounts whose interest is determined to be in an area that is not of interest to the area being examined or within the particular client or research mandate. For example, coupons may often not be of interest.

Text may be broken down into words or “tokenized” to derive meaning. Analysis on the basis of the Shingles making up the artifact is one means of analysis. For example, review on this basis with lone words may yield information related to, for example: presence of exclusionary terms of “stop words”; parts of speech of text elements; linked content (further analysis to be conducted on such content will be discussed in more detail below); Twitter® or other online forum syntax; and results of a lookup of the term using generated vectors. Again, the more data that is generated, the more plentiful and refined the vectors become. Removal of insignificant or unreliable data is helpful as it facilitates more rapid development of more meaningful vectors.

Review of multi-word Shingles can yield additional useful data. For example, significance may be attributed to the appearance of the same 2 word Shingle in a particular relationship or proximity to another term. In other instances, the makeup of a particular Shingles or NGram and its proximity or relationship to other terms (or to the self-identifying or geographic data of the social media user responsible for the artifact) may determine it to be a proper name, a product, a location or otherwise. The identification of such terms may be utilized to provide context when reviewing terms appearing around terms of a certain type. For example, terms know to have a negative connotation appearing adjacent a Shingle determined to be a name may be helpful in determining meaning. However, these determinations are, again, more nuanced, as the nature of social media may require additional analysis. For example, a derogatory comment about a particular individual may be determined to be a potentially humorous statement of support or endorsement if the source of the message is determined to be a friend or colleague. Similarly, the nature and positioning of characters denoting emotion or sarcasm may be of use in deriving more and accurate meaning from a given message.

In many instances, social messages will appear straightforward but rely on the mechanism of the hashtag to provide its actual meaning. Hashtags like #notreally, #sorrynotsorry and others (consistent with statements herein regarding the dynamic and evolving nature of social media and online syntax, new hashtags or other modifiers of this nature emerge almost continuously) can often provide sarcastic or otherwise negating context to an original message, reversing or at least substantially altering the underlying and intended meaning.

Further, the language of social media is often sarcastic in tone. Words such as sick, hot, bad, good, cool, etc., all may appear to mean one thing but in overall context mean the total opposite. It is not enough to understand the literal meaning of a word. Rather, the context in which the word is being used must be ascertained and understood, along with how that context might be different depending on the source.

An additional layer of analysis may be performed where text is determined to be a link to other content. In such cases, the destination of the link will be determined, along with as many surrounding circumstances are available or otherwise subject to determination.

The significance of terms will, in most cases, change over time and in response to gradual changes or, often, sudden events. Any sort of change that is rapidly and massively picked up on by a social media population as being a key moment may trigger a quick and substantial change in language. These include, for example, things as simple and common as a missed goal by a sports team, a word misspoken by a celebrity, or the buffoonery of a local politician.

Triggering events causing a quick (e.g., overnight) change in language may be connected to many external events or may relate to Internet specific developments, for example: a new popular television show with an extremely popular character with a certain name may significantly impact the volume of use and context of that name; the renaming of a sports stadium impacts volume and meaning of the word elements of such name; a band or performer becomes an internet obsession rendering listening against keywords directly associated with this band or performer of diminished value (e.g., notoriety of a given band name makes listening around that name itself extremely difficult for a certain period of time (indeed, monitoring for when this sort of period has ended may be a function of the methods of the present disclosure).

Generally speaking, results will improve as the size of the data set increases and trends and relationships become more clearly defined. This is subject to areas of analysis wherein historic or aged data is less relevant. Refreshing the data set and examining a period of greatest significance for the particular user may be made on an automated basis, with threshold levels (for emergent terms to be added, or terms of diminishing significance removed, as vectors based on a certain monitored volume within the present data set) having been set in a user dictated administrative or configuration construct.

Once a baseline set of data has been created via the analyses described above, a user may have access to a system through which targeted inquiries may be made in a number of manners. Further, the data set may still be grown and the key refreshed as described above.

The user may seek to examine the data set using all or some of the vectors and criteria making up the key. In this manner, the user may take advantage of the depth of analysis provided through the developed vectors and criteria, and may seek to customize their own analyses or examine the significance of altering certain analytical variables.

Certain vectors may be omitted with a view to minimizing processing time. This may be influenced by the size of the data set and the parameters of delivery involved with a given project.

Cut-offs may also be set and customized by way of the thresholds. For example, a significance factor may be the name of a city and its population, with only cities having a population of a certain minimum size being of interest by way of a given inquiry. Further, it may not be necessary to cross reference data in terms of with slang/internet/youth terms, if the scope of sources whose data is being analyzed is limited to a population in which literal use of text can be relied upon with sufficient certainty.

There is also disclosed herein a user experience for the systems and methods of the present disclosure, whereby the user may implement and customize strategies for data analysis and meaning extraction. The systems and methods of the present disclosure may also include methods to measure accuracy and speed (particularly as any system properties are altered) to allow for efficient determination and implementation of enhancements.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps. Methods herein described are exemplary, and performance is intended by software (e.g., stored in memory and/or executed on hardware), hardware, or a combination thereof. Hardware modules may include, for example, a general-purpose processor, and/or analogous equipment. Software modules (executed on hardware) may be expressed in a variety of coded software languages comprising object-oriented, procedural, or other programming language and development tools.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to storage media and hardware devices that are specially configured to store and execute program code

All of the systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A method comprising using a computer to perform the following steps:
obtaining, by a processing device, a data set comprising a plurality of datum;
reviewing, by the processing device, the data set to determine the presence therein of at least one of a plurality of monitoring traits;
analyzing, by the processing device, the data set to extract a secondary data set wherein the secondary data set comprises further data related to each of the datum having at least one monitoring trait;
adjusting, by the processing device, the plurality of monitoring traits based on consideration of the further data;
generating, by the processing device, one or more vectors, wherein each of the vectors comprises one or more path data elements, wherein the path data elements are indicative of the source of each datum;
creating, by the processing device, a key, wherein the key comprises a selected set of the vectors; and,
outputting, by the processing device, the vectors and the key for use in analysis of one or more further data sets.

2. The method according to claim 1, wherein each datum comprises one or more of:
text elements and meta-data elements; and,
wherein the reviewing comprises comparing the text elements and the meta-data elements to one or more of the plurality of monitoring traits.

3. The method according to claim 2, wherein the generating is based on the monitoring traits, wherein each of the vectors comprises a combination of one or more of the text elements, the meta-data and the path data elements, indicative of one or more characteristics of the source of each datum; and the characteristics comprise one or more of age range, geographic location, information reliability, income range, gender, and level of education of the source.

4. The method according to claim 3, wherein the text elements comprise one or more of letters, words, syntax patterns and punctuation.

5. The method according to claim 4, wherein the analyzing comprises: identifying any hyperlinks in each of the datum; identifying any user status details of a creator of each of the datum; identifying the source of each of the datum; determining any interrelationships between the monitoring traits, with relationship including details of any terms occurring in any of the datum having each of the monitored traits, with the details including relative timing of creation.

6. The method according to claim 5, wherein the secondary data comprises one or more of:
content hyperlinked from the datum;
identity of a source of the datum;
geographic location of the source of the datum; and,
timing of creation of the datum;

7. The method according to claim 6, wherein the adjusting further comprises:
assigning a significance level to each of the monitoring traits and each of the further data in the secondary data set, based on one or more significance factors, setting an upper threshold and a lower threshold in respect of each significance level, removing from the monitoring traits any of the monitoring traits having the significance level less than the lower threshold; creating a set of emergent traits, wherein the set of emergent traits comprises any of the further data in the secondary data set having the significance level above the upper threshold; and, adding the emergent traits to the monitoring traits.

8. The method according to claim 7, wherein the significance factors comprise:
textual proximity of a given one of the monitoring traits in the datum to other ones of the monitoring traits;
the words, phrases, symbols and structures making up each datum in the data set;
timing of the message in which the words or phrases appear;
magnitude of a rate of change of prevalence with in the respective data set;
time of creation of the datum;
number of occurrences of the monitored trait within the data set; and, chronology of creation relative to a date of occurrence of a triggering event.

9. The method according to claim 8, further comprising the step of revising one or more of the upper threshold and the lower threshold based on rates of change of the contents of the set of monitoring traits.

10. The method according to claim 1, further comprising a step of further reviewing the data set to determine the presence therein of one or more of the set of emergent traits

11. The method according to claim 1, further comprising:
performing consecutive iterations of the reviewing, the analyzing and the adjusting;
measuring a rate of change between the contents of the data set after each of the iterations; and,
ceasing the performing if the rate of change is less than a desired level.

12. The method according to claim 3, wherein the analyzing further comprises identifying destinations of content hyperlinked from the text elements and the meta-data elements, wherein the content includes additional text and the analyzing further comprises obtaining the additional text; and, the adjusting also includes consideration of the additional text.

13. The method according to claim 12, wherein the analyzing further comprises determining one or more paths between the monitored traits, wherein the paths comprise the path elements and wherein the path elements each comprise one or more words and phrases connecting a pair of the monitoring traits.

14. The method according to claim 13, wherein the analyzing further comprises recording a prevalence level for each of the paths for each of the monitoring traits.

15. The method according to claim 13, wherein the analyzing further comprises recording a plurality of pairs of tokens, wherein each of the pairs of tokens comprises one of the paths and a respective one of the monitoring traits.

16. The method according to claim 1, further comprising determining a velocity of one of the monitoring traits, with the velocity comprising a rapidity of increases or decreases in occurrence of the one of the monitoring traits in the data set over a time interval.

17. The method according to claim 14, further comprising deriving context from the prevalence level of each of the paths.

18. The method according to claim 17, wherein the deriving comprises drawing conclusions regarding one or more characteristics of each datum, wherein the characteristics comprise: age; income level; geographic location; employment status; verified social media account; date of account creation; number of posts by the user(s); nature of relationship with other users of a platform on which the datum was created or on other platforms; times listed and accounts that the user follows; gender; technology use level; level of sophistication; and, level of influence.

19. The method according to claim 1, further comprising recording a time of creation of each of the vectors.

20. The method according to claim 1, further comprising providing a user interface enabling population of the selected set of the vectors from the key for use in consideration of a set of user data to derive market intelligence therefrom.

21. The method according to claim 20, wherein the user interface comprises a plurality of guided selection elements for use in the population and the consideration wherein the guided selection elements comprise a plurality of menu lists from which selections may be made in respect of a plurality of determination variables.

22. Use of a method according to claim 1 to derive market intelligence from the data set.

23. A non-transitory computer readable medium storing a program causing a computer to a process comprising the following steps:
obtaining a data set comprising a plurality of datum;
reviewing the data set to determine the presence of at least one of a set of monitoring traits which includes one or more monitoring traits;
analyzing the data set to extract a secondary data set which includes data related to each of the datum having one or more of the monitoring traits;
adjusting the contents of the set of monitoring traits based on consideration of the data from the secondary data set;
generating a set of vectors, wherein each of the vectors comprises data indicative of the source of each datum; and,
creating a key, wherein the key comprises a selected set of the vectors.

24. A system for market analysis and intelligence derivation, the system comprising:
a processing device for obtaining a data set comprising a plurality of datum;
a review device for reviewing the data set to determine the presence therein of at least one of a plurality of monitoring traits;
an analysis device, for analyzing the data set to extract a secondary data set wherein the secondary data set comprises further data related to each of the datum having at least one monitoring trait;
an adjustment device for adjusting the plurality of monitoring traits based on consideration of the further data;
a generation device for generating one or more vectors, wherein each of the vectors comprises one or more path data elements, wherein the path data elements are indicative of the source of each datum;
a creation device for creating a key, wherein the key comprises a selected set of the vectors; and,
an output device for outputting the vectors and the key for use in analysis of one or more further data sets.
